(19) United States
(12) Patent Application Publication
(10) Pub. No.: US 2026/0320980 A1
(43) Pub. Date: Oct. 15, 2026

(54) Generating Training Datasets For Artificial Neural Networks And Training Artificial Neural Networks

(71) Applicant: Siemens Aktiengesellschaft, Munchen (DE)

(72) Inventors: Martin Bischoff, Garching (DE); Verena Feiner, Garching (DE); Jörg Reh, Erlangen (DE); Martin Raab, Erlangen (DE)

(73) Assignee: Siemens Aktiengesellschaft, Munchen (DE)

(21) Appl. No.: 19/646,106

(22) Filed: Apr. 13, 2026

(30) Foreign Application Priority Data
Apr. 14, 2025 (EP) 25170389.8

(51) Int. Cl. G06V 10/774; G06V 10/26; G06V 10/82

(52) U.S. Cl. CPC G06V 10/774; G06V 10/26; G06V 10/82; G06V 2201/06

(57) ABSTRACT

Various embodiments of the teachings herein include methods for generating a training dataset for training an artificial neural network. An example includes: using a first image, providing an associated parameter; providing a cutout from the first image determined by an element-wise division; and generating the training dataset comprising the cutout and the parameter. The division of the image includes superimposing an image region of a fixed height and width pixel by pixel and/or pixel group by pixel group and/or line by line and/or column by column. The following is carried out for the cutout: a homogeneity is determined, a color intensity is determined; or an edge detection is carried out. The cutouts that are provided are used as second images dependent on the determined homogeneity and/or color intensity and/or a presence of edges.

### CROSS-REFERENCE TO RELATED APPLICATIONS

This application claims priority to EP Application Serial No. 25170389.8 filed Apr. 14, 2025, the contents of which are hereby incorporated by reference in their entirety.

### TECHNICAL FIELD

The present disclosure relates to artificial neural networks. Various embodiments include methods for controlling a production machine.

### SUMMARY

Various embodiments of the teachings herein include methods and systems for operating a production machine. For example, some embodiments include a method for generating a training dataset for training an artificial neural network, comprising: providing a first image; providing a first parameter, the first parameter being associated with the first image; providing at least one second image as a cutout from the first image, the cutout being determined by an element-wise division of the first image; generating the training dataset, the training dataset comprising at least the second image and the associated first parameter, characterized in that the element-wise division of the first image takes place step by step, an image region of a fixed height and width being superposed pixel by pixel and/or pixel group by pixel group and/or line by line and/or column by column with the pixels of the first image, and the region that is superposed in the respective step being provided as a cutout, with the following being carried out in each case for the cutout: a homogeneity, in particular of the pixel-by-pixel color values, is determined and/or; a color intensity, in particular an average sum of the normalized sums of all the RGB values, is determined and/or; an edge detection is carried out, in particular to determine a thickness of the edges, the cutouts that are provided step by step being selected as second images, and used for generating the training dataset, dependent on the determined homogeneity and/or color intensity and/or a presence of edges.

In some embodiments, the element-wise division of the first image takes place by dividing into square cutouts, the square cutouts being provided as second images.

In some embodiments, the second images are provided in a pixel resolution of 224×224 to 227×227.

In some embodiments, in the selection of second images from the determined cutouts, the cutouts with the highest color intensity and/or with the greatest homogeneity and/or with the greatest number of edges, dependent on at least one threshold value, are selected and used for generating the training dataset.

In some embodiments, cutouts which comprise at least parts of motifs, which include in particular logos and/or symbols and/or headings, are selected as second images and used for generating the training dataset.

In some embodiments, the cutouts provided step by step are selected as second images, and used for generating the training dataset, by means of a quality number which is dependent on the determined homogeneity and/or color intensity and/or a presence of edges.

In some embodiments, the training dataset comprises a positional indication for the second image, the positional indication relating to a position within the first image, with the positional indication being provided in particular line by line and/or column by column.

In some embodiments, the first parameter is a contact pressure value.

As another example, some embodiments include a method for training an artificial neural network, characterized in that the artificial neural network is trained with the training dataset as claimed in one of the preceding claims.

As another example, some embodiments include a device, comprising a production machine, a computing unit, a control unit and/or a capturing unit, the capturing unit being designed to capture a first image and to provide it to the computing unit, characterized in that the computing unit comprises an artificial neural network, the artificial neural network being designed to use at least one first image as an input value and to provide a second parameter as an output value; and the control unit is designed to control a control variable, in dependence the determined second parameter.

In some embodiments, the computing unit provides a dataset which links object features that can be processed by the artificial neural network and their position, where, dependent on this respective position, the capturing unit can be aligned by means of the computing unit such that, when capturing a first image, the capturing unit captures the corresponding object feature in the first image.

In some embodiments, the computing unit provides a dataset which links object features that can be processed by the artificial neural network and their position in the first image to be captured such that the capturing unit only detects areas with object features present in the dataset for the first image.

In some embodiments, the production machine is designed as a printing device, the second parameter being a contact pressure value and the control variable taking the form of a contact pressure, which can be controlled dependent on the contact pressure value.

As another example, some embodiments include a computer program product comprising commands which, when the program is executed by a computing unit, in particular a computer, cause the latter to carry out one or more of the methods described herein.

### BRIEF DESCRIPTION OF THE DRAWINGS

Advantages, features, and details of the teachings herein emerge from the exemplary embodiments described below and with reference to the drawings, in which:

FIG. 1 shows a data pipeline as a block diagram, comprising generating training data, training an artificial neural network with the training data and using the artificial neural network for controlling a control variable; and

FIG. 2 shows a device as a block diagram, comprising a production machine, a computing unit, a control unit and a capturing unit.

### DETAILED DESCRIPTION

The teachings of the present disclosure may be used for generating a training dataset for training an artificial neural network. An example includes a method comprising: providing a first image; providing a first parameter, the first parameter being associated with the first image; providing at least one second image as a cutout from the first image, the cutout being determined by an element-wise division of the first image; and generating the training dataset, the training dataset comprising at least the second image and the associated first parameter. The element-wise division of the first image takes place step by step, an image region of a fixed height and width being superposed pixel by pixel and/or pixel group by pixel group and/or line by line and/or column by column with the pixels of the first image, and the region that is superposed in the respective step being provided as a cutout, with the following being carried out in each case for the cutout:
a homogeneity, in particular of the pixel-by-pixel color values, is determined and/or;
a color intensity, in particular an average sum of the normalized sums of all the RGB values, is determined and/or;
an edge detection is carried out, in particular to determine a thickness of the edges, the cutouts that are provided step by step being selected as second images, and used for generating the training dataset, dependent on the determined homogeneity and/or color intensity and/or a presence of edges.

In addition to the second image and the associated first parameter, the training dataset may comprise further parameters, where the first parameter and/or the further parameters may comprise a surface temperature associated with the second image, in particular at the point in time of a production step. Furthermore, counter readings that indicate how often the production step has already taken place may be used as parameters.

The artificial neural network may use a long short-term memory (LSTM) or a gated recurrent unit (GRU) as architectures or be a multi-layer perceptron (MLP) or a transformer model.

The images may be data structures, in particular arrays and/or tables.

The color intensity may describe a purity or strength of a color. In other words, the color intensity may indicate how much a color deviates from a pure gray value. The higher a saturation, the purer and stronger the color appears. Using the example of an RGB color coding of an image point, the color intensity can be calculated as follows:

$$S = \frac{MAX - MIN}{MAX}$$

MAX is the maximum value of an RGB color point, MIN is the minimum value of an RGB color point and S lies in the range [0, 1], where S=0 is an achromatic gray value and S=1 represents a maximum color saturation.

Edge detection may comprise methods which provide detection of significant changes in intensity in images. An edge can be defined mathematically, as a local discontinuity of the image function.

One method for edge detection is the Canny algorithm.

The homogeneity may be a texture measure, in particular for the uniform distribution of color values and/or color intensities of image points.

The present disclosure describes methods for providing the training dataset to train the artificial neural network. The training dataset can dispense with including entire first images and can just include smaller second images. In addition, only second images that meet the criteria for homogeneity and/or color intensity and/or presence of edges are included in the training dataset. As a result, parts of the respective image can be included in the training dataset highly electively, so that the training dataset allows more efficient training of the artificial neural network.

The methods for training the artificial neural network include training the artificial neural network with the training dataset. The training may be provided by means of a method of supervised learning. Advantages that are similar, equivalent, or have the same effect in relation to the methods for generating training data are obtained.

A device incorporating teachings of the disclosure comprises a production machine, a computing unit, a control unit and/or a capturing unit. The capturing unit captures a first image and provide it to the computing unit. The computing unit comprises an artificial neural network, the artificial neural network being designed to use at least one first image as an input value and to provide a second parameter as an output value. The control unit is designed to control a control variable, in dependence on the determined second parameter.

The production machine may be a printing machine and/or conveying equipment. The computing unit may be an industrial computer and/or an edge device or be a virtual computing unit in a cloud. The control unit may be a programmable logic controller.

The capturing unit may be an optical camera and/or an ultrasonic sensor and/or a laser scanner, in particular based on the principle of time-of-flight (ToF) or light-detection-and-ranging (Lidar).

Advantages that are similar, equivalent, or have the same effect in relation to the methods for generating training data are obtained.

Some embodiments include a computer program product comprising commands which, when the program is executed by a computing unit, in particular a computer, cause the latter to carry out one or more of the methods described herein. Advantages that are similar, equivalent, or have the same effect in relation to the method for generating training data are obtained.

In some embodiments, the element-wise division of the first image takes place by dividing into square cutouts, the square cutouts being provided as second images. As a result, it is possible to provide the cutouts even more quickly, since the dividing takes place in fewer steps, in particular in fewer steps than in the case of dividing pixel by pixel.

In some embodiments, the second images are provided in a pixel resolution of 224×224 to 227×227. The pixel resolution may describe the number of image points (pixels) of a digital image in the horizontal direction and vertical direction. As a result, artificial neural networks that have already been trained with images in these pixel resolutions can be advantageously further trained efficiently with the training data provided.

In some embodiments, in the selection of second images from the determined cutouts, the cutouts with the highest color intensity and/or with the greatest homogeneity and/or with the greatest number of edges, dependent on at least one threshold value, are selected and used for generating the training dataset. As a result, it is possible to fix a threshold value, where the threshold value may be adaptable to react to changing parameters.

In some embodiments, cutouts which comprise at least parts of motifs, which include in particular logos and/or symbols and/or headings, are selected as second images and used for generating the training dataset. From the viewpoint of image processing, motifs, symbols, logos or headings can represent recurring patterns and/or image characteristics. As a result, a detection of recurring patterns can be used as a strength of the image processing. In other words, knowledge of recurring patterns is used in particular to simplify retraining. This is the case because, despite their differences, certain images share these same patterns. Training based on these commonalities can therefore simplify retraining of the artificial neural network or allow direct further use of the existing network.

In some embodiments, the cutouts provided step by step are selected as second images, and used for generating the training dataset, by means of a quality number which is dependent on the determined homogeneity and/or color intensity and/or a presence of edges. The quality number may represent a threshold value which, when exceeded or not reached, acts as a basis on which the selection of the image can take place. To include the various metrics (homogeneity, color intensity and presence of edges), the quality number may be a weighted sum.

The weighted sum can weight the individual metrics to varying degrees by a variation of the weightings. As a result, it is possible to react to changes of parameters by means of a variation of the weightings, in particular by means of a dynamic variation. This may allow a consistent quality to be achieved in the operation of the production machine.

In some embodiments, the training dataset comprises a positional indication for the second image, the positional indication relating to a position within the first image, with the positional indication being provided in particular line by line and/or column by column. The positional indication may indicate where the second image is located within the first image. Furthermore, the positional indication may be specified relative to a position of a camera, so that a camera can be aligned dependent on the positional indication. As a result, it is possible that, in a capture of the first image, only selected regions, dependent on the positional indication, are captured, and thus a data volume is reduced. This is the case because the positional indication can be used to exclude other regions from the capture.

In some embodiments, the first parameter is a contact pressure value. The contact pressure value may represent the contact pressure of a printing plate and/or a printing stamp, in particular for printing machines and/or presses. As a result, it is possible to control more efficiently mechatronic devices that can exert a variable pressure.

In some embodiments, the computing unit provides a dataset which links object features that can be processed by the artificial neural network and their position, where, dependent on this respective position, the capturing unit can be aligned by means of the computing unit such that, when capturing a first image, the capturing unit captures the corresponding object feature in the first image. Object features may be distinguished by certain metrics (homogeneity, color intensity and presence of edges). Object features may be assigned the position, which may be relative to the capturing unit and/or a higher-level reference system, in particular a surrounding space (room, hall or building).

The alignment capability of the capturing unit may be provided by the capturing unit being aligned by the computing unit and dependent on the position in the dataset. A one-time alignment of the capturing unit such that all possible positions according to the dataset can be captured is also a possible training. As a result, the capture of the first image can be provided while involving a lower data volume. This is the case because areas with object features can be captured with preference.

In some embodiments, the computing unit provides a dataset which links object features that can be processed by the artificial neural network and their position in the first image to be captured such that the capturing unit only captures areas with object features present in the dataset for the first image. As a result, it is possible to reduce the volume of data involved when capturing the first image. This is the case because the computing unit uses virtual cutting to cut out areas without object features and only captures areas with object features present in the dataset for the first image.

In some embodiments, the production machine is designed as a printing device, the second parameter being a contact pressure value and the control variable taking the form of a contact pressure, which can be controlled dependent on the contact pressure value. The printing device may be a printing machine for printed products. As a result, more efficient control of the printing machine can be provided.

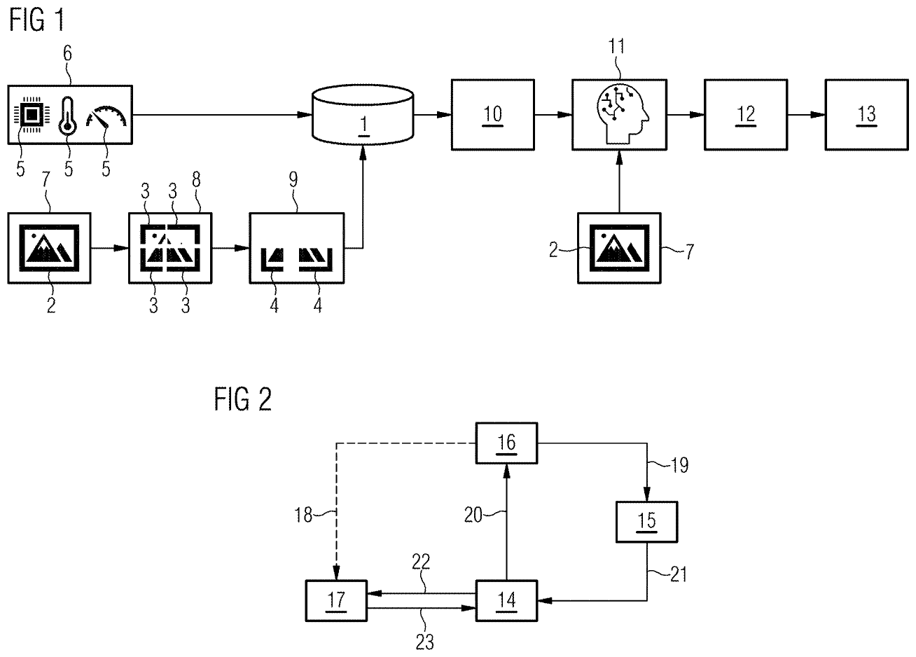

FIG. 1 shows a schematic representation of a data pipeline incorporating teachings of the present disclosure in the form of a block diagram. The data pipeline includes the training dataset 1, with data being provided 6, 9 for this dataset and the training dataset 1 being further used for training 10 an artificial neural network.

The providing of data takes place by two different providing processes, to be specific providing 5 a first parameter 6 and providing 7 a first image 2.

The providing 5 of the first parameter 6 may comprise sensor-based data such as pressure, temperature, velocity, rotational speed, etc. Another possibility is that of providing design data for a machine, in particular type numbers and/or a date when it was last serviced.

The providing 7 of the first image 2 may take place by means of a capturing unit, in particular an optical camera.

An element-wise division 8 of the first image 2 may take place by an image region of a fixed height and width being superposed pixel by pixel and/or pixel group by pixel group and/or line by line and/or column by column with the pixels of the first image 2, and the region that is superposed in the respective step being provided as a cutout 3.

The cutouts 3 are selected as second images 4 by means of at least one of the following metrics:
1. Homogeneity: A uniformity of a distribution of color values and/or color intensities of image points is determined.
2. Color intensity: A strength/purity of the colors is determined image point by image point, in particular an average sum of the normalized sums of the RGB values of the image points.
3. Presence of edges: Edges can be extracted from the cutout by means of an edge detection algorithm such as the Canny algorithm. The number of edges and/or the length of the edges can then be determined.

For providing 9 second images 4, a selection of suitable cutouts 3 takes place. The selection may be made using an evaluation logic, the metrics being compared individually with a respective threshold value and selected or not selected dependent on whether the threshold is exceeded or not reached. Further logical operations are possible, in particular requiring that only one metric, at least one metric or all metrics must be satisfied, in particular threshold values exceeded. Alternatively, a single threshold value may be used, in particular as a quality number which is determined with a result of a weighted summation as all three metrics. In this case, a value is calculated for each metric, is weighted with a fixed weighting and all the metrics are summed. The result is a weighted sum that can be matched against a threshold value and, as a result, the respective cutout is provided as a second image.

The training dataset 1 is generated on the basis of the two providing processes 6, 9. In this case, the first parameters 5 are linked with at least one second image 4, whereby these are then associated with one another. This same association exists between the first parameter 5 and the first image 2, with the association transitioning to the second image 4. The term association can be understood as meaning that a first parameter 5 was captured at a similar point in time as the first image 2 and/or a control, in particular of a machine, by means of the first parameter 5 leads to a result which was captured in image 2.

The training 10 of the artificial neural network may take place by means of the training dataset 1 and the method of supervised learning. The training 10 may be a retraining, an already trained artificial neural network being trained further. Retraining aims to retrain the artificial neural network for a new specific application. The retraining may be less time- and/or cost-intensive than a complete training of a new artificial neural network.

The inference 11 by means of the artificial neural network takes place by the first image 2 being provided as an input value, though the first image 2 does not have to be the same first image 2 from the training dataset. Rather, it may be a further first image 2 with similar features, in particular with similar metrics. The artificial neural network provides a second parameter 12 as an output value.

In some embodiments, the provided second parameter 12 may be used for controlling 13 the control variable. An example of such controlling 13 would be the controlling of a contact pressure of a printing machine in dependence on the second parameter, which may in particular be a contact pressure value as a setpoint value.

Another example of such controlling 13 would be the controlling of a temperature and/or a baking time of a baking machine in dependence on the second parameter, which may in particular be a temperature value and/or a baking time value as a setpoint value.

FIG. 2 shows a block diagram of a system incorporating teachings of the present disclosure which reproduces the data flows between a control unit 14, a capturing unit 16, a production machine 17 and a computing unit 15.

The control unit 14 may initiate the capture 18 of the first image with the data flow 20 periodically and/or dependent on the capture of the first parameter by means of the data flow 23. If the capturing unit 16 is a camera unit, it may be aligned with products passing through the production machine 17. When the capturing unit 16 has captured a first image, it provides the first image to the computing unit 15 by means of the data flow 19.

The computing unit 15 is designed to provide the artificial neural network and to feed first images to the same as input values. By inference 11, the artificial neural network then provides 21 the second parameter for the control unit 14.

The control unit 14 is designed for controlling 22 the control variable by means of the second parameter. The controlling 22 may take place by way of a connection to the production machine 17 by means of commonly used communication protocols, in particular Modbus, CAN bus, OPC-UA, MQTT, etc.

Elements that are similar, equivalent, or have the same effect may be provided with the same reference signs in one of the figures or in the figures.

Although the teachings herein have been illustrated more specifically and described in detail by the examples, the scope of the disclosure is not restricted by the examples disclosed, or other variations may be derived therefrom by a person skilled in the art without departing from the scope of protection thereof.

### LIST OF REFERENCE SIGNS

1 Training dataset
2 First image
3 Cutout
4 Second images
5 First parameter
6 Providing the first parameter
7 Providing the first image
8 Element-wise division of the first image
9 Providing the second images
10 Training an artificial neural network
11 Inference by means of the artificial neural network
12 Providing a second parameter
13 Controlling a control variable by means of the second parameter
14 Control unit
15 Computing unit
16 Capturing unit
17 Production machine
18 Capturing the first image
19 Providing a second image
20 Initiating a capture
21 Providing a second parameter
22 Controlling a control variable by means of the second parameter
23 Providing the first parameter

1. A method for generating a training dataset for training an artificial neural network, the method comprising:
providing a first image;
providing a first parameter associated with the first image;
providing a second image as a cutout from the first image, the cutout determined by an element-wise division of the first image;
generating the training dataset comprising the second image and the first parameter;
wherein the element-wise division of the first image includes step-by-step superimposing an image region of a fixed height and width pixel by pixel and/or pixel group by pixel group and/or line by line and/or column by column with the pixels of the first image, and the region that is superposed in the respective step makes up a cutout;
in each case for the cutout, determining a homogeneity, a color intensity, and/or an edge detection; and
selecting the cutouts provided step-by-step as second images for generating the training dataset, dependent on the determined homogeneity and/or color intensity and/or a presence of edges.

2. The method as claimed in claim 1, wherein:
the element-wise division of the first image includes dividing into square cutouts; and
the square cutouts are used as second images.

3. The method as claimed in claim 1, wherein the second images have a pixel resolution of 224×224 to 227×227.

4. The method as claimed in claim 1, wherein, the selection of second images from the determined cutouts includes selecting the cutouts with the highest color intensity and/or with the greatest homogeneity and/or with the greatest number of edges, dependent on at least one threshold value.

5. The method as claimed in claim 1, wherein selecting the second image include selecting a cutout which is part of motifs in particular logos and/or symbols and/or headings.

6. The method as claimed in claim 1, wherein selecting the cutouts provided step by step includes assessment of a quality number which is dependent on the determined homogeneity and/or color intensity and/or a presence of edges.

7. The method as claimed in claim 1, wherein the training dataset comprises a positional indication for the second image, the positional indication relating to a position within the first image, with the positional indication being provided line by line and/or column by column.

8. The method as claimed in claim 1, wherein the first parameter comprises a contact pressure value.

9. A method for training an artificial neural network, the method comprising:
providing a first image;
providing a first parameter associated with the first image;
providing a second image as a cutout from the first image, the cutout determined by an element-wise division of the first image;
generating the training dataset, the training dataset comprising the second image and the first parameter;
wherein the element-wise division of the first image takes place step-by-step, an image region of a fixed height and width being superposed pixel by pixel and/or pixel group by pixel group and/or line by line and/or column by column with the pixels of the first image, and the region that is superposed in the respective step is provided as a cutout, with the following carried out in each case for the cutout:
a homogeneity, in particular of the pixel-by-pixel color values, is determined and/or;
a color intensity, in particular an average sum of the normalized sums of all the RGB values, is determined and/or;
an edge detection is carried out, in particular to determine a thickness of the edges; and
the cutouts that are provided step-by-step are selected as second images, and used for generating the training dataset, dependent on the determined homogeneity and/or color intensity and/or a presence of edges; and
training the artificial neural network with the training dataset.

10. A device comprising:
a production machine;
a computing unit comprising an artificial neural network designed to use a first image as an input value and provide a second parameter as an output value;
a control unit; and
a camera to capture a first image and transmit the first image to the computing unit;
wherein the control unit is designed to control a control variable in dependence on the determined second parameter.

11. The device as claimed in claim 10, wherein the computing unit provides a dataset which links object features that can be processed by the artificial neural network and their position, where, dependent on this respective position, the capturing unit can be aligned by means of the computing unit such that, when capturing a first image, the capturing unit captures the corresponding object feature in the first image.

12. The device as claimed in claim 10, wherein the computing unit provides a dataset which links object features that can be processed by the artificial neural network and their position in the first image to be captured such that the capturing unit only detects areas with object features present in the dataset for the first image.

13. The device as claimed in claim 10, wherein:
the production machine comprises a printing device;
the second parameter includes a contact pressure value; and
the control variable includes a contact pressure, which can be controlled dependent on the contact pressure value.
